(19) United States
(12) Patent Application Publication
(10) Pub. No.: US 2024/0084459 A1
(43) Pub. Date: Mar. 14, 2024

(54) COMPOSITIONS AND METHODS FOR DISSOLVING IRON SULFIDE AND INHIBITING CORROSION

(71) Applicant: ECOLAB USA Inc., St. Paul, MN (US)

(72) Inventors: Juan Manuel GARCIA, III, Sugar Land, TX (US); Ashish DHAWAN, Aurora, IL (US); Carter Martin SILVERNAIL, Lakeville, MN (US); Maria DeJesus MARQUEZ, Houston, TX (US); Emily Rebecca WOOD, Naperville, IL (US); Oussama ZENASNI, Richmond, TX (US); Ravindranath MUKKAMALA, Sugar Land, TX (US); Jonathan MASERE, Richmond, TX (US); Ramon COLORADO, JR., Stafford, TX (US)

(73) Assignee: ECOLAB USA Inc., St. Paul, MN (US)

(21) Appl. No.: 18/358,787

(22) Filed: Jul. 25, 2023

Related U.S. Application Data
(60) Provisional application No. 63/402,615, filed on Aug. 31, 2022.

(51) Int. Cl. C23F 11/14; C09K 8/532; C09K 8/54

(52) U.S. Cl. CPC C23F 11/149; C09K 8/532; C09K 8/54; C09K 2208/32

(57) ABSTRACT

The present disclosure provides methods and compositions for inhibiting corrosion of metallic surfaces and dissolving iron sulfide deposits in aqueous systems. A method may include adding a composition to the aqueous medium. The composition may include malic acid or a salt thereof. The composition may optionally include an organic solvent and/or a corrosion inhibitor.

### TECHNICAL FIELD

The present disclosure provides compositions and method for cleaning, dissolving and/or inhibiting corrosion. More particularly, the disclosure provides compositions and methods for removing oilfield hydrocarbon and iron sulfide based deposits from equipment and optionally for providing protection to the equipment against corrosive fluids and gases.

### BACKGROUND

As oilfields age, the amount of oil produced decreases and the amount of water produced with the oil increases. The water is usually disposed of or injected back into the formation to maintain reservoir pressure. The separation process is efficient, but not perfect, and a small fraction of oil and other debris can be present after the fluids pass through the separation equipment. That residual fraction of oil in water carryover can cause significant problems as the field ages. Fields can produce as much as 1,000,000 barrels of water each day. The residual oil and other particles, such as paraffin, asphaltenes, iron sulfide and biomass can build up in the separation equipment and pipelines. If left untreated, this form of deposition can plug lines, which can lead to loss of revenue and/or equipment failure. Due to lines which cannot be mechanically cleaned, a chemical solution is needed that can be injected into the system to maintain control of the deposition in the lines.

Fluids produced in the oil and gas industry can be quite corrosive to the infrastructure by which it is produced. This internal corrosion of pipelines and production equipment is commonly treated using chemical corrosion inhibitors. Corrosion inhibitors work primarily by forming protective films on the surfaces of the infrastructure. This creates a protective barrier from the corrosive fluids. If deposits, such as deposits comprising iron sulfide, are present on internal surfaces, they do not allow the dosed corrosion inhibitor to effectively coat and protect the equipment.

Such unwanted deposits may be complex mixtures of inorganic compounds, such as sand and iron sulfide, and organic compounds, such as asphaltenes and crude petroleum. The deposits are sticky and difficult to clean. Currently, commercially available cleaners for removing deposits from equipment used in oil and gas applications aid in the removal of the organic deposition but are less effective against the inorganic deposition, especially iron sulfide. Conventional cleaners may disperse iron sulfide, but are relatively ineffective in inhibiting or dissolving iron sulfide, providing only limited cleaning ability. Conventional cleaners may also be acidic and therefore incompatible with the metallurgy of the systems they are designed to treat.

### BRIEF SUMMARY

In certain aspects, the present disclosure provides methods of inhibiting corrosion of a metallic surface in an aqueous system. Further, the present disclosure provides methods of dissolving an iron sulfide deposit in an aqueous system. Additionally, the present disclosure provides methods of dissolving an iron sulfide deposit and inhibiting corrosion of a metallic surface in an aqueous system.

The methods comprise adding a composition to the aqueous medium, wherein the composition comprises malic acid or a salt thereof.

In some embodiments, the composition comprises an organic solvent. The organic solvent may comprise, for example, an alcohol, a hydrocarbon, a ketone, an ether, an alkylene glycol, a glycol ether, an amide, a nitrile, a sulfoxide, an ester, a polyol, or any combination thereof.

The organic solvent may comprise methanol, ethanol, propanol, isopropanol, butanol, 2-ethylhexanol, hexanol, octanol, decanol, 2-butoxyethanol, methylene glycol, ethylene glycol, 1,2-propylene glycol, 1,3-propylene glycol, diethyleneglycol monomethyl ether, diethylene glycol monoethyl ether, ethylene glycol monobutyl ether, ethylene glycol dibutyl ether, pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, glycerin, or any combination thereof.

In some embodiments, the composition comprises a corrosion inhibitor selected from the group consisting of an imidazoline compound, a quaternary ammonium compound, a pyridinium compound, and any combination thereof.

In certain embodiments, the corrosion inhibitor comprises one or more of the following imidazoline compounds: (A) an imidazoline of Formula (I).

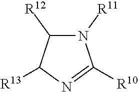

wherein R¹⁰ is a C₁-C₂₀ alkyl or a C₁-C₂₀ alkoxyalkyl group;
R¹² and R¹³ are independently hydrogen or a C₁-C₆ alkyl group; and
R¹¹ is independently hydrogen, a C₁-C₆ alkyl, a C₁-C₆ hydroxyalkyl, an aminoalkyl, an aminoaryl, an aminoarylalkyl, an aminoalkylaryl, or a C₁-C₆ arylalkyl;
(B) an imidazolinium salt of Formula (II):

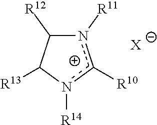

wherein R¹⁰ is a C₁-C₂₀ alkyl or a C₁-C₂₀ alkoxyalkyl group;
R¹² and R¹³ are independently hydrogen or a C₁-C₆ alkyl group;
R¹¹ and R¹⁴ are independently hydrogen, a C₁-C₆ alkyl, a C₁-C₆ hydroxyalkyl, or a C₁-C₆ arylalkyl; and
X is a halide, a carbonate, a sulfonate, a phosphate, or an anion of an organic carboxylic acid;
(C) a bis-quaternized imidazoline compound of Formula (III):

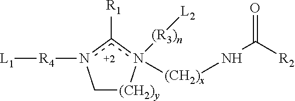

wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof;
R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof;
L₁ and L₂ are each independently absent, H, —COOH, —SO₃H, —PO₃H₂, —COOR₅, —CONH₂, —CONHR₅, or —CON(R₅)₂;
R⁵ is each independently a branched or unbranched alkyl, aryl, alkylaryl, alkylheteroaryl, cycloalkyl, or heteroaryl group having from 1 to about 10 carbon atoms;
n is 0 or 1, and when n is 0, L₂ is absent or H;
x is from 1 to about 10; and
y is from 1 to about 5; or
(D) a combination thereof.

In some embodiments, the corrosion inhibitor comprises the imidazoline of Formula (I) or the imidazolinium salt of Formula (II), R¹⁰ is an alkyl mixture of tall oil fatty acid (TOFA), R¹¹ is benzyl, R¹² and R¹³ are each hydrogen, R¹⁴ is hydroxyethyl, and X⁻ is chloride.

In some embodiments, the corrosion inhibitor comprises the bis-quaternized imidazoline compound of Formula (III), R₁ and R₂ are derived from a mixture of tall oil fatty acids and are predominantly a mixture of C₁₇H₃₃ and C₁₇H₃₁, x is 2, y is 1, R₃ and R₄ are —C₂H₂—, and L₁ and L₂ are —CO₂H, —SO₃H, or —PO₃H₂.

In certain embodiments, the corrosion inhibitor comprises the bis-quaternized imidazoline compound of Formula (III), R₁ and R₂ independently C₁₆-C₁₈ alkyl; R₄ is —C₂H₂—; x is 2; y is 1; n is 0; L₁ is —COOH, —SO₃H, or —PO₃H₂ and L₂ is absent or H.

In some embodiments, the corrosion inhibitor comprises the quaternary ammonium compound and the bis-quaternized imidazoline compound of Formula (III).

In some embodiments, the corrosion inhibitor comprises a pyridinium compound of Formula (V):

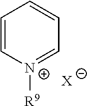

wherein R⁹ is an alkyl group, an aryl group, or an arylalkyl group, wherein said alkyl groups have from 1 to about 18 carbon atoms; and X⁻ is a halide. In certain embodiments, R⁹ is benzyl and X is a chloride.

In some embodiments, the corrosion inhibitor further comprises a member selected from the group consisting of an alkoxylated amine, a phosphate ester, a monomeric fatty acid, an oligomeric fatty acid, and any combination thereof.

In some embodiments, the composition comprises from about 5 wt. % to about 95 wt. % of the malic acid.

In certain embodiments, the composition comprises from about 5 wt. % to about 95 wt. % of the organic solvent.

In some embodiments, the composition comprises from about 5 wt. % to about 95 wt. % of the corrosion inhibitor.

In some embodiments, the composition comprises from about 15 wt. % to about 30 wt. % of the malic acid, from about 20 wt. % to about 40 wt. % of the organic solvent, and from about 15 wt. % to about 30 wt. % of the corrosion inhibitor.

In certain embodiments, the composition further comprises a compound of formula HS—(CH₂)ₙOH, wherein n is 2-6.

In some embodiments, the composition further comprises thioglycolic acid, 3,3′-dithiodipropionic acid, thiourea, 2-mercaptoethanol, L-cysteine, tert-butyl mercaptan, sodium thiosulfate, ammonium thiosulfate, sodium thiocyanate, ammonium thiocyanate, sodium metabisulfite, or any combination thereof.

In some embodiments, the composition further comprises an asphaltene inhibitor, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, a surfactant, or any combination thereof.

In some embodiments, a surface in the aqueous system comprises the iron sulfide deposit.

In any of the foregoing embodiments, the composition may comprise a pH modifier.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE SEVERAL VIEWS OF THE DRAWINGS

A detailed description of the invention is hereafter described with specific reference being made to the drawings in which:

FIG. 1 shows the results of a bubble cell test;

FIG. 2 shows the results of a bubble cell test;

FIG. 3 shows the results of an iron sulfide dissolution test;

FIG. 4 shows the results of an iron sulfide dissolution test; and

FIG. 5 shows the results of an iron sulfide dissolution test.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2n electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Halogen” or “halo” refers to F, Cl, Br, and I.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

“Oxo” refers to an oxygen atom double-bonded to a carbon atom.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions for inhibiting corrosion and/or removing iron sulfide deposits in oil and gas processes. In some embodiments, a composition comprises an iron sulfide dissolver, such as malic acid and/or a salt thereof, which may be used to dissolve iron sulfide. Compositions disclosed herein may optionally comprise other components, such as a solvent (e.g., an organic solvent) and a corrosion inhibitor, which may comprise, for example, a functionalized imidazoline compound, a quaternary ammonium compound, a pyridinium compound, a quaternary iminium compound, a zwitterionic betaine compound, an amidoamine compound, or any combination thereof. In some embodiments, the compositions disclosed herein exclude a solvent, a corrosion inhibitor, and/or phosphorous.

The compositions disclosed herein are useful in crude oil-based and natural gas-based products, processes, and refinery streams. The compositions are effective for inhibiting corrosion of mild steel in hydrocarbon, oil/brine mixtures, and aqueous systems. The compositions are also useful for removing hydrocarbonaceous deposits from metallic and/or mineral surfaces in contact with a fluid in oil and gas applications, including removal of iron sulfide to reduce the risk of corrosion failures due to under deposit corrosion. The compositions can be used in sweet systems (i.e., systems having a relatively high carbon dioxide concentration) or in systems having sour conditions (i.e., relatively high hydrogen sulfide concentration). The compositions are useful in a wide range of climates and under a wide range of process conditions, such as from about 0° C. to about 200° C., where other available cleaner/corrosion inhibitor compositions fail.

The iron sulfide dissolver comprises malic acid. The iron sulfide dissolver may optionally comprise a multi-functional hydroxy-carboxylic acid and/or additional components, such as allaric acid, altaric acid, altraric acid, altronic acid, arabinaric acid, arabinonic acid, citric acid, dihomocitric acid, fructuronic acid, fuconic acid, fumaric acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, xyluronic acid, tartaric acid, tatronic acid, glyceric acid, malonic acid and pantoic acid, a salt of any of these acids, or any combination thereof. Suitable salts of the iron sulfide dissolver include alkali metal and alkaline earth metal salts, such as sodium, potassium, lithium, magnesium, calcium and cesium salts. The iron sulfide dissolver inhibits the formation of iron sulfide and/or dissolves iron sulfide.

The iron sulfide dissolver may be present in a composition in an amount ranging from about 1 wt. % to about 100 wt. %, such as from about 1 wt. % to about 90 wt. %, about 1 wt. % to about 80 wt. %, about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, about 5 wt. % to about 100 wt. %, about 10 wt. % to about 100 wt. %, about 20 wt. % to about 100 wt. %, about 30 wt. % to about 100 wt. %, about 40 wt. % to about 100 wt. %, about 50 wt. % to about 100 wt. %, about 60 wt. % to about 100 wt. %, about 70 wt. % to about 100 wt. %, about 80 wt. % to about 100 wt. %, or about 90 wt. % to about 100 wt. %, based on total weight of the composition.

The compositions disclosed herein may include an additional component, such as a corrosion inhibitor. The corrosion inhibitor may be present in an amount of about 0 wt. % to about 95 wt. %, such as from about 1 wt. % to about 75 wt. %, about 5 wt. % to about 50 wt. %, or about 10 wt. % to about 25 wt. %, based on total weight of the composition.

Suitable corrosion inhibitors include, but are not limited to, alkyl, hydroxyalkyl, alkylaryl, arylalkyl or arylamine quaternary salts, mono or polycyclic aromatic amine salts, imidazoline derivatives, mono-, di- or trialkyl or alkylaryl phosphate esters, phosphate esters of hydroxylamines, phosphate esters of polyols, an ester of alcoholamine, and/or monomeric and/or oligomeric fatty acids.

In some embodiments, the corrosion inhibitor comprises an imidazoline. The imidazoline may be, for example, imidazoline derived from a diamine, such as ethylene diamine (EDA), diethylene triamine (DETA), triethylene tetraamine (TETA), etc., and a long chain fatty acid, such as TOFA.

The imidazoline may be an imidazoline of Formula (I) and/or a derivative thereof. Representative imidazoline derivatives include, but are not limited to, an imidazolinium compound of Formula (II) or a bis-quaternized compound of Formula (III).

Suitable imidazolines include those of Formula (I):

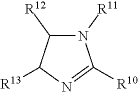

wherein R¹⁰ is a C₁-C₂₀ alkyl or a C₁-C₂₀ alkoxyalkyl group; R¹¹ is independently hydrogen, a C₁-C₆ alkyl, a C₁-C₆ hydroxyalkyl, an aminoalkyl, an aminoaryl, an aminoarylalkyl, an aminoalkylaryl, or a C₁-C₆ arylalkyl; and R¹² and R¹³ are independently hydrogen or a C₁-C₆ alkyl group. In some embodiments, the imidazoline includes an R¹⁰ which is the alkyl mixture typical in TOFA, and R¹¹, R¹² and R¹³ are each hydrogen.

The corrosion inhibitor component may include an imidazolinium compound of Formula (II):

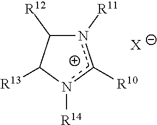

wherein R¹⁰ is a C₁-C₂₀ alkyl or a C₁-C₂₀ alkoxyalkyl group; R¹¹ and R¹⁴ are independently hydrogen, C₁-C₆ alkyl, C₁-C₆ hydroxyalkyl, or C₁-C₆ arylalkyl;
R¹² and R¹³ are independently hydrogen or a C₁-C₆ alkyl group; and X⁻ is a halide (such as chloride, bromide, or iodide), carbonate, sulfonate, phosphate, or the anion of an organic carboxylic acid (such as acetate). In some embodiments, the imidazolinium compound includes 1-benzyl-1-(2-hydroxyethyl)-2-tall-oil-2-imidazolinium chloride.

The corrosion inhibitor may comprise a bis-quaternized compound having the Formula (III):

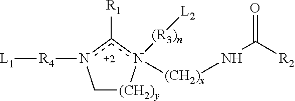

wherein R₁ and R₂ are each independently substituted or unsubstituted branched, chain or ring alkyl or alkenyl having from 1 to about 29 carbon atoms, partially or fully oxygenized, sulfurized, and/or phosphorylized branched, chain, or ring alkyl or alkenyl having from 1 to about 29 carbon atoms, or a combination thereof;
R₃ and R₄ are each independently unsubstituted branched, chain or ring alkylene or alkenylene having from 1 to about 29 carbon atoms, partially or fully oxygenized, sulfurized, and/or phosphorylized branched, chain, or ring alkylene or alkenylene having from 1 to about 29 carbon atoms, or a combination thereof;
L₁ and L₂ are each independently absent, H, —COOH, —SO₃H, —PO₃H₂, —COOR₅, —CONH₂, —CONHR₅, or —CON(R₅)₂; R₅ is each independently a branched or unbranched alkyl, aryl, alkylaryl, alkylheteroaryl, cycloalkyl, or heteroaryl group having from 1 to about 10 carbon atoms; n is 0 or 1, and when n is 0, L₂ is absent or H; x is from 1 to about 10; and y is from 1 to about 5.

In some embodiments, R₁ and R₂ are each independently C₆-C₂₂ alkyl, C₈-C₂₀ alkyl, C₁₂-C₁₈ alkyl, C₁₆-C₁₈ alkyl, or a combination thereof; R₃ and R₄ are alkylene, C₂-C₈alkylene, C₂-C₆alkylene, or C₂-C₃alkylene; n is 0 or 1; x is 2; y is 1; R₃ and R₄ are —C₂H₂—; L₁ is —COOH, —SO₃H, or —PO₃H₂; and L₂ is absent, H, —COOH, —SO₃H, or —PO₃H₂. For example, R₁ and R₂ can be derived from a mixture of tall oil fatty acids and are predominantly a mixture of C₁₇H₃₃ and C₁₇H₃₁ or can be C₁₆-C₁₈ alkyl; R₃ and R₄ can be C₂-C₃ alkylene, such as —C₂H₂—; n is 1 and L₂ is —COOH or n is 0 and L₂ is absent or H; x is 2; y is 1; R₃ and R₄ are —C₂H₂—; and L₁ is —COOH.

In certain embodiments, the number of carbon atoms specified for each group of Formula (III) refers to the main chain of carbon atoms and does not include carbon atoms that may be contributed by substituents.

The corrosion inhibitor may comprise a bis-quaternized imidazoline compound having the Formula (III) wherein R₁ and R₂ are each independently C₆-C₂₂ alkyl, C₈-C₂₀ alkyl, C₁₂-C₁₈ alkyl, or C₁₆-C₁₈ alkyl or a combination thereof; R₄ is C₁-C₁₀ alkylene, C₂-C₈ alkylene, C₂-C₆ alkylene, or C₂-C₃ alkylene; x is 2; y is 1; n is 0; L₁ is —COOH, —SO₃H, or —PO₃H₂; and L₂ is absent or H. In some embodiments, a bis-quaternized compound has the Formula (III) wherein R₁ and R₂ are each independently C₁₆-C₁₈ alkyl; R₄ is —C₂H₂—; x is 2; y is 1; n is 0; L₁ is —COOH, —SO₃H, or —PO₃H₂ and L₂ is absent or H.

The imidazoline and/or imidazolinium compound may comprise about 0 to about 100 wt. %, about 10 to 60 wt. %, or about 30 to 45 wt. % of the corrosion inhibitor component, based on total weight of the corrosion inhibitor component. For example, the imidazoline and/or imidazolinium compound can constitute about 10 to about 70 wt. %, about 20 to about 60 wt. %, or about 30 to 40 wt. % of the corrosion inhibitor component, based on total weight of the corrosion inhibitor component.

The corrosion inhibitor may be a quaternary ammonium compound of Formula (IV):

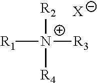

wherein R₁, R₂, and R₃ are independently C₁ to C₂₀ alkyl, R₄ is methyl or benzyl, and X⁻ is a halide or methosulfate.

Suitable alkyl, hydroxyalkyl, alkylaryl, arylalkyl or aryl amine quaternary salts include those alkylaryl, arylalkyl and aryl amine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary salts, R^{5a}, R^{6a}, R^{7a}, and R^{8a} can each be independently selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms and at least one aryl group, and X is Cl, Br or

Suitable quaternary ammonium salts include, but are not limited to, a tetramethyl ammonium salt, a tetraethyl ammonium salt, a tetrapropyl ammonium salt, a tetrabutyl ammonium salt, a tetrahexyl ammonium salt, a tetraoctyl ammonium salt, a benzyltrimethyl ammonium salt, a benzyltriethyl ammonium salt, a phenyltrimethyl ammonium salt, a phenyltriethyl ammonium salt, a cetyl benzyldimethyl ammonium salt, a hexadecyl trimethyl ammonium salt, a dimethyl alkyl benzyl quaternary ammonium salt, a monomethyl dialkyl benzyl quaternary ammonium salt, or a trialkyl benzyl quaternary ammonium salt, wherein the alkyl group has about 6 to about 24 carbon atoms, about 10 and about 18 carbon atoms, or about 12 to about 16 carbon atoms.

In some embodiments, the quaternary ammonium salt can be a benzyl trialkyl quaternary ammonium salt, a benzyl triethanolamine quaternary ammonium salt, or a benzyl dimethylaminoethanolamine quaternary ammonium salt.

The quaternary ammonium salts may comprise about 0 to about 100 wt. %, about 20 to 80 wt. %, or about 50 to 65 wt. % of the corrosion inhibitor component, based on total weight of the corrosion inhibitor component. For example, the quaternary ammonium salt may comprise about 10 to about 90 wt. %, about 30 to about 70 wt. %, or about 50 to about 60 wt. % of the corrosion inhibitor component, based on total weight of the corrosion inhibitor component.

The corrosion inhibitor component may comprise a pyridinium salt such as those represented by Formula (V):

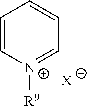

wherein R⁹ is an alkyl group, an aryl group, or an arylalkyl group, wherein said alkyl groups have from 1 to about 18 carbon atoms, and X is a halide, such as chloride, bromide, or iodide. Among these compounds are alkyl pyridinium salts and alkyl pyridinium benzyl quats. Examples of compounds include, but are not limited to, methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium chloride and an alkyl benzyl pyridinium chloride. In some embodiments, the alkyl is a C₁-C₆ hydrocarbyl group. In certain embodiments, the pyridinium compound includes benzyl pyridinium chloride.

The pyridinium salt may constitute about 0 to about 100 wt. %, about 10 to about 60 wt. %, or about 30 to about 40 wt. % of the corrosion inhibitor component, based on total weight of the corrosion inhibitor component.

The corrosion inhibitor component may include an additional corrosion inhibitor, such as a phosphate ester, a monomeric or oligomeric fatty acid, and/or an alkoxylated amine.

In some embodiments, the corrosion inhibitor component comprises a phosphate ester. Suitable mono-, di- and tri-alkyl as well as alkylaryl phosphate esters and phosphate esters of mono-, di-, and triethanolamine typically contain between about 1 and about 18 carbon atoms. Examples of mono-, di- and trialkyl phosphate esters, alkylaryl or arylalkyl phosphate esters are those prepared by reacting a C₃-C₁₈ aliphatic alcohol with phosphorous pentoxide. The phosphate intermediate interchanges its ester groups with triethylphosphate producing a more broad distribution of alkyl phosphate esters. Alternatively, the phosphate ester may be made by admixing with an alkyl diester or a mixture of low molecular weight alkyl alcohols and/or diols. The low molecular weight alkyl alcohols and/or diols may include C₆ to C₁₀ alcohols and/or diols. Additional examples include phosphate esters of polyols and their salts containing one or more 2-hydroxyethyl groups, and hydroxylamine phosphate esters obtained by reacting polyphosphoric acid or phosphorus pentoxide with hydroxylamines, such as diethanolamine or triethanolamine.

In some embodiments, the corrosion inhibitor component may include a monomeric and/or oligomeric fatty acid. Examples of monomeric and/or oligomeric fatty acids include C₁₄-C₂₂ saturated and unsaturated fatty acids, as well as dimer, trimer and oligomer products obtained by polymerizing one or more of such fatty acids.

The corrosion inhibitor component may comprise an alkoxylated amine. The alkoxylated amine may be an ethoxylated alkyl amine, for example. In some embodiments, the alkoxylated amine comprises ethoxylated tallow amine. The alkoxylated amine may comprise about 0 wt. % to about 100 wt. %, about 10 wt. % to about 60 wt. %, or about 20 wt. % to about 30 wt. % of the corrosion inhibitor component, based on total weight of the corrosion inhibitor component.

In some embodiments, the compositions disclosed herein may comprise a solvent. The solvent may be present in an amount of about 0 wt. % to about 99 wt. %, about 5 wt. % to about 95 wt. %, about 20 wt. % to about 80 wt. %, or about 40 wt. % to about 60 wt. %, based on total weight of the composition. In some embodiments, the solvent constitutes about 5, about 10, about 15, about 20, about 25, about 30, about 35, about 40, about 45, about 50, about 55, about 60, about 65, about 70, about 75, about 80, about 85, about 90 or about 95 wt. % of the composition.

Suitable solvents include, but are not limited to, an alcohol, a hydrocarbon, a ketone, an ether, an alkylene glycol, a glycol ether, an amide, a nitrile, a sulfoxide, an ester, and water. The solvent may comprise water, isopropanol, methanol, ethanol, 2-ethylhexanol, heavy aromatic naphtha, toluene, ethylene glycol, ethylene glycol monobutyl ether, diethylene glycol monoethyl ether, and/or xylene.

The solvent may be a polar solvent, such as water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), an alkylene glycol (such as methylene glycol, ethylene glycol, 1,2-propylene glycol, 1,3-propylene glycol, etc.), a glycol ether (such as diethyleneglycol monomethyl ether, ethylene glycol monobutyl ether, ethylene glycol dibutyl ether, etc.), a ketone (such as cyclohexanone or diisobutylketone), an ether (such as diethyl ether), an alkylene carbonate (such as propylene carbonate), N-methylpyrrolidinone (NMP), N,N-dimethylformamide, a polyol (such as glycerin), and the like.

Illustrative, non-limiting examples of non-polar solvents suitable for formulation with the composition include, but are not limited to, aliphatic hydrocarbons, such as pentane, hexane, cyclohexane, methylcyclohexane, heptane, decane, dodecane, diesel, and the like; aromatic hydrocarbons, such as toluene, xylene, and heavy aromatic naphtha; and fatty acid derivatives, such as acids, esters, and amides.

The solvent may be compatible with an arctic environment. For example, methanol, ethanol, ethylene glycol or glycerin improve the anti-freeze properties of the composition. Such solvent is typically present in an amount of about 5 wt. % to about 15 wt. %, such as about 10 wt. %, based on total weight of the composition to have an anti-freeze effect.

In some embodiments, the compositions disclosed herein may include a sulfur-containing compound. If present, the sulfur-containing compound can be included in an amount of about 0.1 wt. % to about 25 wt. %, about 0.5 wt. % to about 20 wt. %, about 1 wt. % to about 10 wt. %, or about 1 wt. % to about 5 wt. %, based on total weight of the composition. The sulfur-containing compound may constitute about 0.1, about 0.5, about 1, about 2, about 3, about 4, about 5, about 6, about 7, about 8, about 9, about 10, about 11, about 12, about 13, about 14, about 15, about 16, about 17, about 18, about 19 or about 20 wt. % of the composition, based on total weight of the composition.

Suitable sulfur-containing compounds include, but are not limited to, compounds that enhance the corrosion inhibiting and/or cleaning performance of the composition. The sulfur-containing compound may include, for example, thioglycolic acid, 3,3′-dithiodipropionic acid, thiourea, 2-mercaptoethanol, L-cysteine, tert-butyl mercaptan, sodium thiosulfate, ammonium thiosulfate, sodium thiocyanate, ammonium thiocyanate, sodium metabisulfite, or any combination thereof. In some embodiments, the sulfur-containing compound is 2-mercaptoethanol.

The compositions may optionally include an additive. Suitable additives include, but are not limited to, an asphaltene inhibitor, a paraffin inhibitor, a scale inhibitor, an emulsifier, a water clarifier, a dispersant, an emulsion breaker, a hydrogen sulfide scavenger, a gas hydrate inhibitor, a biocide, an antifoam, a pH modifier, and/or a surfactant. A composition disclosed herein may comprise from about 0.1 wt. % to about 10 wt. %, from about 0.1 wt. % to about 5 wt. %, or from about 0.5 wt. % to about 3 wt. % of the additive or combination of additives.

Suitable asphaltene inhibitors include, but are not limited to, aliphatic sulfonic acids, alkyl aryl sulfonic acids, aryl sulfonates, lignosulfonates, alkylphenol/aldehyde resins and/or similar sulfonated resins, polyolefin esters, polyolefin imides, polyolefin esters with alkyl, alkylenephenyl or alkylenepyridyl functional groups, polyolefin amides, polyolefin amides with alkyl, alkylenephenyl or alkylenepyridyl functional groups, polyolefin imides with alkyl, alkylenephenyl or alkylenepyridyl functional groups, alkenyl/vinyl pyrrolidone copolymers, graft polymers of polyolefins with maleic anhydride or vinyl imidazole, hyperbranched polyester amides, polyalkoxylated asphaltenes, amphoteric fatty acids, salts of alkyl succinates, sorbitan monooleate, and polyisobutylene succinic anhydride.

Suitable paraffin inhibitors include, but are not limited to, paraffin crystal modifiers and dispersant/crystal modifier combinations. Suitable paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax and/or asphaltenes.

Suitable scale inhibitors include, but are not limited to, phosphates, phosphate esters, phosphoric acids, phosphonates, phosphonic acids, polyacrylam ides, salts of acrylamidomethyl propane sulfonate/acrylic acid copolymer (AMPS/AA), phosphinated maleic copolymer (PHOS/MA), and salts of a polymaleic acid/acrylic acid/acrylamidomethyl propane sulfonate terpolymer (PMA/AA/AM PS).

Suitable emulsifiers include, but are not limited to, salts of carboxylic acids, products of acylation reactions between carboxylic acids or carboxylic anhydrides and amines, and alkyl, acyl and amide derivatives of saccharides (alkyl-saccharide emulsifiers).

Suitable water clarifiers include, but are not limited to, inorganic metal salts such as alum, aluminum chloride, and aluminum chlorohydrate, or organic polymers such as acrylic acid based polymers, acrylamide based polymers, polymerized amines, alkanolamines, thiocarbamates, and cationic polymers, such as diallyldimethylammonium chloride (DADMAC).

Suitable dispersants include, but are not limited to, aliphatic phosphonic acids with 2-50 carbons, such as hydroxyethyl diphosphonic acid, and aminoalkyl phosphonic acids, e.g., polyaminomethylene phosphonates with 2-10 N atoms, each bearing at least one methylene phosphonic acid group, examples of the latter including ethylenediamine tetra(methylene phosphonate), diethylenetriamine penta(methylene phosphonate), and the triamine- and tetramine-polymethylene phosphonates with 2-4 methylene groups between each N atom, at least 2 of the numbers of methylene groups in each phosphonate being different. Other suitable dispersants include lignin, or derivatives of lignin, such as lignosulfonate and naphthalene sulfonic acid and derivatives. In some embodiments, a dispersant is selected from dodecyl benzene sulfonate, an oxyalkylated alkylphenol, and/or an oxyalkylated alkylphenolic resin.

Suitable emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, and resins, such as phenolic and epoxide resins.

Suitable hydrogen sulfide scavengers include, but are not limited to, oxidants (e.g., inorganic peroxides, such as sodium peroxide or chlorine dioxide); aldehydes (e.g., of 1-10 carbons, such as formaldehyde, glyoxal, glutaraldehyde, acrolein, or methacrolein; and triazines (e.g., monoethanolamine triazine, monomethylamine triazine, and triazines from multiple amines or mixtures thereof).

Suitable gas hydrate inhibitors include, but are not limited to, thermodynamic hydrate inhibitors, kinetic hydrate inhibitors, and anti-agglomerates. Suitable thermodynamic hydrate inhibitors include, but are not limited to, sodium chloride, potassium chloride, calcium chloride, magnesium chloride, sodium bromide, formate brines (e.g., potassium formate), polyols (such as glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, and triglycerol), sugar alcohols (e.g., sorbitol and mannitol), methanol, propanol, ethanol, glycol ethers (such as diethyleneglycol monomethylether, ethyleneglycol monobutylether), and alkyl or cyclic esters of alcohols (such as ethyl lactate, butyl lactate, methylethyl benzoate).

Suitable kinetic hydrate inhibitors and anti-agglomerates include, but are not limited to, polymers and copolymers, polysaccharides (such as hydroxyethylcellulose, carboxymethylcellulose, starch, starch derivatives, and xanthan), lactams (such as polyvinylcaprolactam, polyvinyl lactam), pyrrolidones (such as polyvinyl pyrrolidone of various molecular weights), surfactants (such as fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, and alkyl amido betaines), hydrocarbon-based dispersants (such as lignosulfonates, iminodisuccinates, and polyaspartates), amino acids, and proteins.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2-bromo-2-nitropropane-3-diol (Bronopol) and 2-2-dibromo-3-nitrilopropionamide (DBNPA)), sulfur compounds (e.g., isothiazolone, carbamates, and metronidazole), and quaternary phosphonium salts (e.g., tetrakis(hydroxymethyl)-phosphonium sulfate (THPS)). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable pH modifiers include, but are not limited to, alkali hydroxides, alkali carbonates, alkali bicarbonates, alkaline earth metal hydroxides, alkaline earth metal carbonates, alkaline earth metal bicarbonates and mixtures or combinations thereof. For example, a pH modifier may include sodium hydroxide, potassium hydroxide, calcium hydroxide, calcium oxide, sodium carbonate, potassium carbonate, sodium bicarbonate, potassium bicarbonate, magnesium oxide, and magnesium hydroxide. In some embodiments, a pH modifier may comprise a hydrophilic or amphiphilic amine, such as methyldiethanolamine (MDEA).

Suitable surfactants include, but are not limited to, anionic surfactants and nonionic surfactants. Anionic surfactants include alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono- and dialkyl sulfosuccinates and sulfosuccinamates. Nonionic surfactants include, but are not limited to, alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, and alkoxyl polyethylene glycol esters and diesters. Also included are betaines and sultanes, amphoteric surfactants, such as alkyl amphoacetates and amphodiacetates, alkyl amphopropionates and amphodipropionates, and alkyliminodipropionate.

The surfactant may be a quaternary ammonium compound, an amine oxide, an ionic or nonionic surfactant, or any combination thereof. Suitable quaternary ammonium compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhexyl) dimethyl quaternary ammonium methyl sulfate.

In some embodiments, a composition disclosed herein comprises the following Formula 1:

| Product ID | Weight (%) | Chemistry description |
|---|---|---|
| Formula 1 | about 25 | Benzyl-(C12-C18 Linear Alkyl)-Dimethyl- |
| | | Ammonium Chloride, Tall Oil Fatty Acids, |
| | | Rxn Product with diethylenetriamine and |
| | | Acrylic Acid |
| | about 37 | Malic acid, about 50% |
| | about 18 | Methanol |
| | about 20 | Water |

In some embodiments, a composition disclosed herein comprises the following Formula 2:

| Product ID | Weight (%) | Chemistry description |
|---|---|---|
| Formula 2 | about 25 | Benzyl-(C12-C18 Linear Alkyl)-Dimethyl- |
| | | Ammonium Chloride, Tall Oil |
| | | Fatty Acids, Rxn Product with |
| | | diethylenetriamine and Acrylic Acid |
| | about 25 | Malic acid, about 50% |
| | about 40 | DI Water |
| | about 5 | Methanol |
| | about 5 | Propylene Glycol |

In some embodiments, a composition disclosed herein comprises the following Formula 3:

| Product ID | Weight (%) | Chemistry description |
|---|---|---|
| Formula 3 | about 14 | Benzyl-(C12-C18 Linear Alkyl)-Dimethyl- |
| | | Ammonium Chloride |
| | about 2 | 2-mercaptoethanol |
| | about 14 | Malic acid |
| | about 55 | Tap water |
| | about 5 | Methanol |
| | about 5 | Propylene glycol |
| | about 0.01 | Silicone antifoam |
| | about 5 | TOFA-DETA Imidazoline |

In some embodiments, a composition disclosed herein comprises the following Formula 4:

| Product ID | Weight (%) | Chemistry description |
|---|---|---|
| Formula 4 | about 38 | Methanol |
| | about 10 | 1-(1-ethylamino)-imidazoline |
| | about 10 | 1-(1-hydroxyethyl)-imidazoline |
| | about 2 | 2-mercaptoethanol |
| | about 40 | About 50% (w/w) aqueous malic acid |

In some embodiments, a composition disclosed herein comprises the following Formula 5:

| Product ID | Weight (%) | Chemistry description |
|---|---|---|
| Formula 5 | about 38 | Methanol |
| | about 14 | Benzyl-(C12-C18 Linear Alkyl)-Dimethyl- |
| | | Ammonium Chloride |
| | about 5 | 1-(1-ethylamino)-imidazoline |
| | about 2 | 2-mercaptoethanol |
| | about 41 | About 50% (w/w) aqueous malic acid |

In some embodiments, a composition disclosed herein comprises the following Formula 6:

| Product ID | Weight (%) | Chemistry description |
|---|---|---|
| Formula 6 | about 38 | Methanol |
| | about 14 | Benzyl-(C12-C18 Linear Alkyl)-Dimethyl- |
| | | Ammonium Chloride |
| | about 5 | 1-(1-hydroxyethyl)-imidazoline |
| | about 2 | 2-mercaptoethanol |
| | about 41 | About 50% (w/w) aqueous malic acid |

In some embodiments, a composition disclosed herein comprises the following Formula 7:

| Product ID | Weight (%) | Chemistry description |
|---|---|---|
| Formula 7 | about 38 | Methanol |
| | about 20 | Malic acid |
| | about 20 | Butyl glycol |
| | about 5 | 1-(1-ethylamino)-imidazoline |
| | about 2 | 2-mercaptoethanol |
| | about 15 | Triethanolamine (TEA)- |
| | | TOFA ester in xylene |

In some embodiments, a composition disclosed herein comprises the following Formula 8:

| Product ID | Weight (%) | Chemistry description |
|---|---|---|
| Formula 8 | about 38 | Methanol |
| | about 20 | Malic acid |
| | about 20 | Butyl glycol |
| | about 5 | 1-(1-hydroxyethyl)-imidazoline |
| | about 2 | 2-mercaptoethanol |
| | about 15 | TEA-TOFA ester in xylene |

In some embodiments, the compositions disclosed herein consist of or consist essentially of any component (or combination of components) disclosed in Formulas 1 to 8.

In some embodiments, compositions of the present disclosure may be prepared by combining the iron sulfide dissolver with a solvent to form a solution. If desired, additional components, such as a corrosion inhibitor, a sulfur-containing compound, a solvent, and/or an additive may be added to the solution.

The compositions of the present disclosure may be used for dissolving iron sulfide, inhibiting corrosion and/or removing hydrocarbonaceous deposits in oil and gas applications. The compositions may be used in any industry where it is desirable to dissolve iron sulfide, inhibit corrosion and/or remove hydrocarbonaceous deposits from a surface.

In some embodiments, the present disclosure provides a method of dissolving an iron sulfide deposit in an aqueous system. The method comprises adding a composition to the aqueous medium, wherein the composition comprises malic acid or a salt thereof. In some embodiments, the present disclosure provides a method of inhibiting corrosion of a metallic surface in an aqueous system. The method comprises adding a composition to the aqueous medium, wherein the composition comprises malic acid or a salt thereof.

In some embodiments, a method of the present disclosure may be carried out by treating a gas and/or liquid stream with an effective amount of a composition as described herein. The methods may be carried out in aqueous systems, oil systems and/or gas systems. For example, the compositions and methods may be used for dissolving iron sulfide deposits on heat exchanger surfaces. Certain methods may include applying a composition disclosed herein to a gas or liquid produced or used in the production, transportation, storage, and/or separation of crude oil or natural gas. In some embodiments, the compositions may be applied to a gas stream used or produced in a coal-fired process, such as a coal-fired power plant. In certain embodiments, the compositions may be applied to a gas or liquid produced or used in a waste-water process, a farm, a slaughter house, a land-fill, a municipality waste-water plant, a coking coal process, and/or a biofuel process.

The compounds and compositions disclosed herein may be added to an aqueous medium. The aqueous medium may comprise water, gas, and/or liquid hydrocarbon. In some embodiments, a compound or composition may be added to a liquid hydrocarbon. The liquid hydrocarbon can be any type of liquid hydrocarbon including, but not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, and any combination thereof. In some embodiments, the fluid or gas may comprise a refined hydrocarbon product.

A fluid or gas treated with a composition of the present disclosure may be at any selected temperature, such as ambient temperature or an elevated temperature. The fluid (e.g., liquid hydrocarbon) or gas may be at a temperature of from about 40° C. to about 250° C. In some embodiments, the fluid or gas may be at a temperature of from about −50° C. to about 300° C., about 0° C. to about 200° C., about 10° C. to about 100° C., or about 20° C. to about 90° C. For example, the fluid or gas may be at a temperature of about −20° C., about −15° C., about −10° C., about −5° C., or about 0° C. In certain embodiments, the fluid or gas can be found in an arctic environment and can have a temperature and salinity typical of such an environment.

The compositions of the disclosure may be added to a fluid at various levels of water cut. For example, the water cut may be from about 0% to about 100% volume/volume (v/v), from about 1% to about 80% v/v, or from about 1% to about 60% v/v. The fluid may be an aqueous medium that contains various levels of salinity. For example, the fluid may have a salinity of about 0% to about 25%, about 1% to about 24%, or about 10% to about 25% weight/weight (w/w) total dissolved solids (TDS).

The fluid and/or gas to which the compositions of the disclosure are introduced can be contained in and/or exposed to many different types of devices. For example, the fluid and/or gas may be contained in a device or apparatus that transports fluid or gas from one point to another, such as an oil and/or gas pipeline. The device or apparatus can be part of an oil and/or gas refinery, such as a pipeline, a separation vessel, a dehydration unit, or a gas line. The compositions can be introduced to large diameter flow lines of from about 1 inch to about 4 feet in diameter, small gathering lines, small flow lines and headers. The fluid can be contained in and/or exposed to an apparatus or device used in oil extraction and/or production, such as a wellhead. The device or apparatus may be part of a coal-fired power plant. The device or apparatus may be a scrubber (e.g., a wet flue gas desulfurizer, a spray dry absorber, a dry sorbent injector, a spray tower, a contact or bubble tower, or the like). The device or apparatus may be a cargo vessel, a storage vessel, a holding tank, or a pipeline connecting the tanks, vessels, or processing units.

The compositions may be introduced into a fluid or gas by any appropriate method for ensuring dispersal through the fluid or gas. In some embodiments, a composition may be added to the hydrocarbon fluid before the hydrocarbon fluid contacts a surface in the system. The composition may be added at a point in a flow line upstream from the point at which iron sulfide is to be dissolved and/or corrosion is to be prevented. The compositions may be injected/added using mechanical equipment, such as chemical injection pumps, piping tees, injection fittings, atomizers, quills, and the like. In certain embodiments, the compositions of the disclosure may be pumped into an oil and/or gas pipeline using an umbilical line. In other embodiments, a capillary injection system may be used to deliver the composition to a selected fluid.

The compositions may be injected into a stream as an aqueous or non-aqueous solution, a mixture, or a slurry. The compositions may be applied to a fluid or gas to provide any selected concentration of components. For example, the composition may be added to a flow line to provide an effective treating dose of the desired component, such as iron sulfide dissolver, corrosion inhibitor, etc., from about 0.01 to about 5,000 ppm. The compositions may be applied to a fluid or gas to provide a concentration of iron sulfide dissolver, corrosion inhibitor, etc., of about 1 ppm to about 1,000,000 ppm, about 1 ppm to about 100,000 ppm, about 10 ppm to about 75,000 ppm, about 10 ppm to about 50,000 ppm, about 10 ppm to about 25,000, about 10 ppm to about 10,000 ppm, about 200 ppm to about 8,000 ppm, or about 500 ppm to about 6,000 ppm.

In accordance with the methods disclosed herein, the composition may be applied continuously, in batch, or a combination thereof. For example, a dosage rate for continuous treatment may range from about 10 ppm to about 500 ppm or about 10 ppm to about 200 ppm. A dosage rate for batch treatments may range from, for example, about 10 ppm to about 400,000 ppm or about 10 ppm to about 20,000 ppm. The composition can also be applied as a pill to a pipeline, for example, to provide a high dose (e.g., about 20,000 ppm) of a component, such as iron sulfide dissolver and/or corrosion inhibitor, of the composition.

The foregoing may be better understood by reference to the following examples, which are intended for illustrative purposes and are not intended to limit the scope of the disclosure or its application in any way.

### Examples

The bubble cell test was used to investigate the effectiveness of the compositions disclosed herein as corrosion inhibitors. This test measures the corrosion rate of a steel electrode in an aqueous environment by linear polarization resistance (LPR). Carbon steel electrodes (C1018) were placed in a synthetic brine solution, which was deaerated with carbon dioxide. The corrosion rates determined from LPR measurements of C1018 coupons immersed in a synthetic brine dosed with about 50,000 ppm (about 5 wt. %) of the compositions were determined from LPR measurements. The pH of the brine was between about 5.5 and 6.0. The brine solution was sparged with CO₂ for about 16 hours prior to the beginning of the test. Table 1 summarizes the test conditions.

TABLE 1
Summary of Test Conditions

| Parameter | Value | |
|---|---|---|
| Temperature | 80° | C. |
| Purging Gas | CO₂ | |
| Stirring Rate | 100 | rpm |
| Brine Composition | 4.70 g CaCl₂, 6.0 g MgCl₂, | |
| | 1.10 g KCl, 0.80 g Na₂SO₄, | |
| | 14.0 g NaHCO₃, 171.5 g NaCl, | |
| | 0.90 g NaBr, 9.0 g acetic | |
| | acid and 10 L H₂O | |
| Total Liquid Volume | 900 | mL |
| Coupon Metallurgy | C1018 | |
| Test Length | 24 | hours |
| Formulation Dose | 50,000 | ppm |

| | |
|---|---|
| Formula 1 | As defined above |
| Formula 2 | As defined above |
| Blank | Brine |

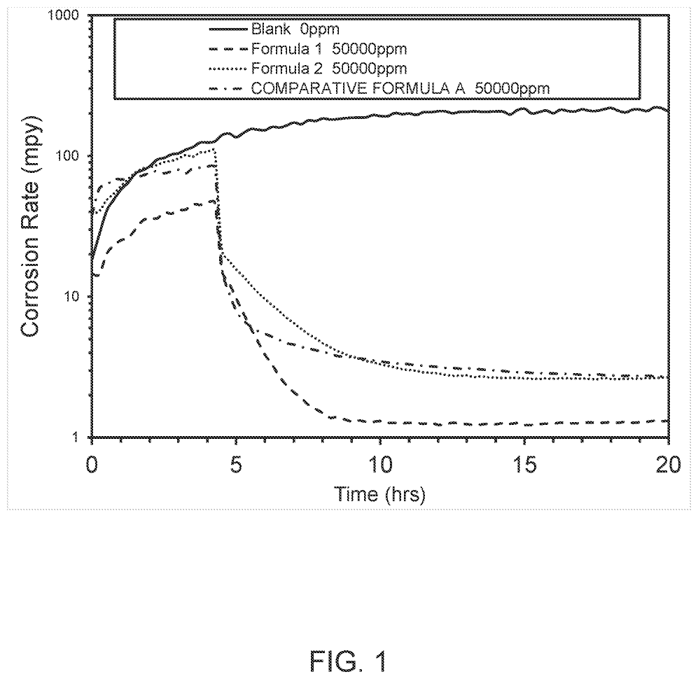

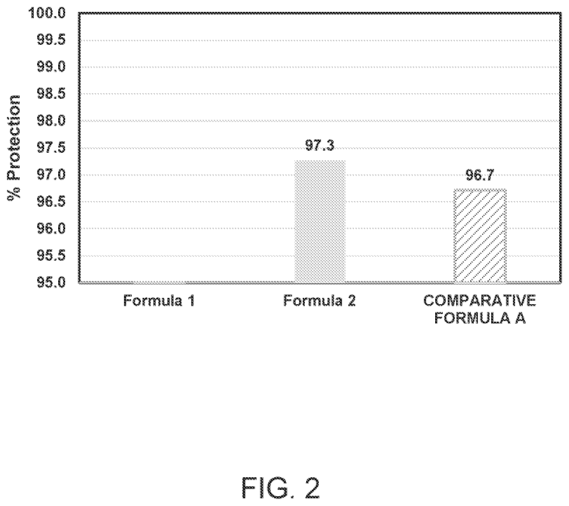

The results of the bubble test are shown in FIGS. 1 and 2, wherein “mpy” is mils per year. Corrosion rates were obtained in the absence of the test formula for about four hours to establish a baseline corrosion rate. After introduction of the formulation, the corrosion rates sharply decreased until a plateau was reached.

The corrosion inhibition of Formula 1 and 2 (see paragraphs and [0093]) was compared directly to COMPARATIVE FORMULA A in a synthetic brine solution at equivalent dosages. Both Formula 1 and 2 exhibited similar performance to COMPARATIVE FORMULA A, which contains 10-30 wt. % of a quaternary ammonium compound, 5-10 wt. % of a fatty acid-amine condensate, 5-10 wt. % of methanol, 1-5 wt. % ethylene glycol, 1-5 wt. % 2-mercaptoethanol, and 1-5 wt. % isopropanol.

In an additional set of experiments, the ability of various acids to dissolve iron sulfide was tested. Parameters are shown in Table 2 and results are shown in Table 3.

TABLE 2

| Theoretical Fe | 30 | ppm |
|---|---|---|
| Dissolver dosage | 50 | ppm |
| Water Source | DI Water, 3.5% Sea Salt Water, Synthetic Brine | |
| Filter size | 0.22 | um |

TABLE 3

| | | Solubilized |
|---|---|---|
| | | Fe % 0.22 |
| Dissolver (50 ppm) | Water Source | um |
| Blank | DI Water | 19% |
| Gluconic Acid | DI Water | 40% |
| Malic Acid | DI Water | 73% |
| Disodium Maleate | DI Water | 1% |
| Maleic Acid | DI Water | 58% |
| Galacturonic Acid | DI Water | 49% |
| Glucuronic Acid | DI Water | 46% |
| Mucic Acid | DI Water | 38% |
| Blank | 3.5% Sea Salt | 0% |
| Gluconic Acid | 3.5% Sea Salt | 10% |
| Malic Acid | 3.5% Sea Salt | 48% |
| Disodium Maleate | 3.5% Sea Salt | 0% |
| Maleic Acid | 3.5% Sea Salt | 36% |
| Galacturonic Acid | 3.5% Sea Salt | 7% |
| Glucuronic Acid | 3.5% Sea Salt | 8% |
| Mucic Acid | 3.5% Sea Salt | 13% |
| Blank | Synthetic Brine | 0% |
| Gluconic Acid | Synthetic Brine | 48% |
| Malic Acid | Synthetic Brine | 101% |
| Disodium Maleate | Synthetic Brine | 0% |
| Maleic Acid | Synthetic Brine | 69% |
| Galacturonic Acid | Synthetic Brine | 43% |
| Glucuronic Acid | Synthetic Brine | 37% |
| Mucic Acid | Synthetic Brine | 56% |

As can be seen in Table 3, the inventors discovered that malic acid performed unexpectedly better than all other acids tested in all water sources.

The effectiveness of the inventive compositions disclosed herein as dissolvers of iron sulfide was determined according to the following procedure. Firstly, two aqueous solutions were prepared. The first solution comprised a synthetic brine of about 5.64 g of calcium chloride (CaCl₂)), about 7.2 g of magnesium chloride (MgCl₂), about 1.32 g of potassium chloride (KCl), about 0.96 g of sodium sulfate (Na₂SO₄), about 16.8 g of sodium bicarbonate (NaHCO₃), about 205.8 g of sodium chloride (NaCl), about 1.08 g of sodium bromide (NaBr), about 10.8 g acetic acid and about 12 L of demineralized water. The second aqueous solution included about 3.5% (w/w) of sea water in demineralized water. The solutions were incubated at about 65° C. To each solution, iron chloride and sodium sulfide were added to afford an aqueous iron sulfide composition of about 30 ppm. In addition to the synthetic brine and the diluted sea water, deionized water was also used.

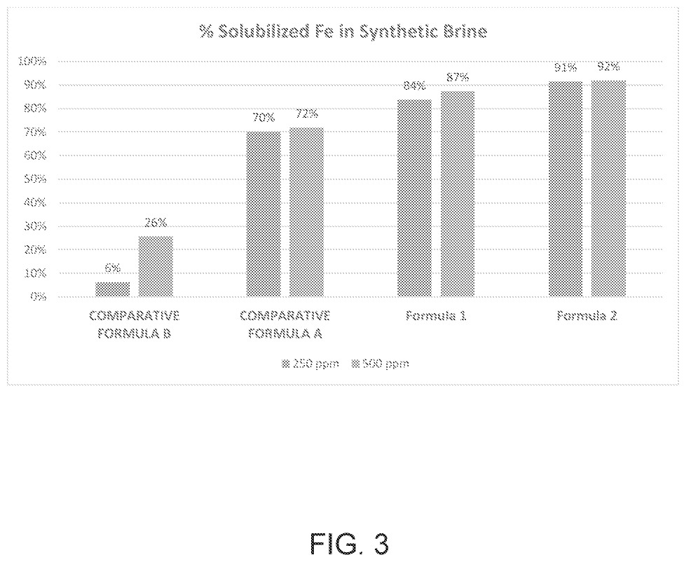

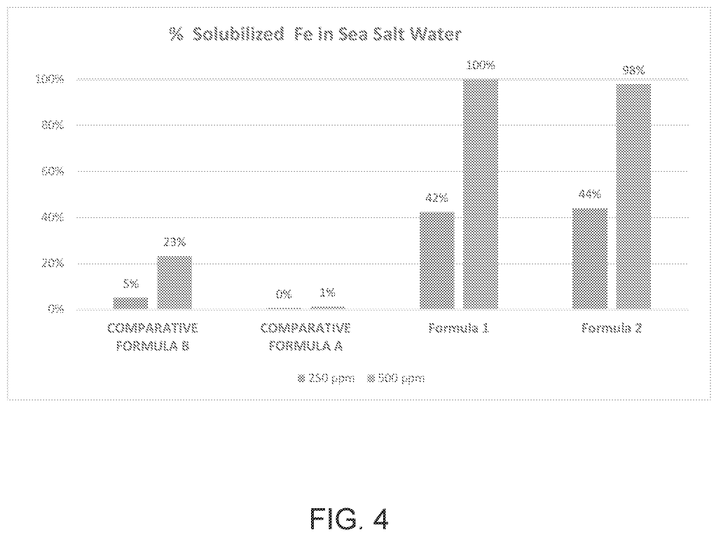

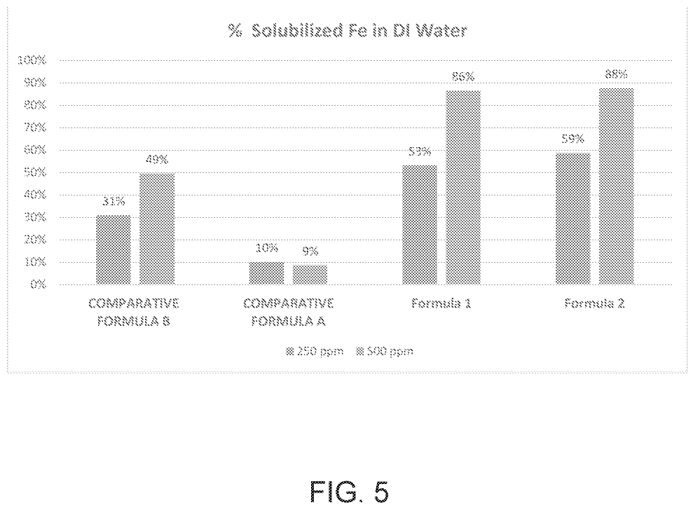

Each of the prepared solutions was dosed with about 250 ppm of the formulation candidate. Likewise, another potion of the solutions was treated with about 500 ppm of the formulation candidate. The treated solutions were subsequently incubated at about 65° C. for another 30 minutes. Thereafter, the solutions were filtered using a 0.2-micron filter. The filtrate was collected and analyzed for iron concentration using inductively coupled plasma (ICP). The results of the inventive compositions and comparative formulations are shown in Tables 4-5 and FIGS. 3-5.

TABLE 4
Dissolver in DI water

| | @ 250 ppm | @ 500 ppm |
|---|---|---|
| | Filtered Fe % | Filtered Fe % |
| Dissolver | 0.22 um | 0.22 um |
| Comparative Formula B | 46% | 70% |
| Comparative Formula A | 25% | 45% |
| Formula 1 | 48% | 88% |
| Formula 2 | 46% | 86% |
| Formula 3 | 44% | 82% |
| Formula 4 | 48% | 89% |
| Formula 5 | 52% | 88% |
| Formula 6 | 53% | 72% |
| Formula 7 | 49% | 72% |
| Formula 8 | 48% | 79% |

TABLE 5
Dissolver in 3.5% Sea salt water

| | @ 250 ppm | @ 500 ppm |
|---|---|---|
| | Filtered Fe % | Filtered Fe % |
| Dissolver | 0.22 um | 0.22 um |
| Comparative | 10% | 39% |
| Formula B | | |
| Comparative | 0% | 1% |
| Formula A | | |
| Formula 1 | 15% | 81% |
| Formula 2 | 14% | 83% |
| Formula 3 | 17% | 71% |
| Formula 4 | 18% | 72% |
| Formula 5 | 22% | 70% |
| Formula 6 | 23% | 77% |
| Formula 7 | 19% | 72% |
| Formula 8 | 16% | 71% |

As can be seen, the inventive Formulas are significantly more effective in dissolving iron sulfide compared to COMPARATIVE FORMULA A and COMPARATIVE FORMULA B, which contains 10-30 wt. % methanol, 10-30 wt. % tetrakis(hydroxymethyl)phosphonium sulfate, 10-30 wt. % of a quaternary ammonium compound, 5-10 wt. % of a fatty acid-amine condensate, 1-5 wt. % of 2-mercaptoethanol, and 1-5 wt. % isopropanol.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2% or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of dissolving an iron sulfide deposit in an aqueous system, comprising:
adding a composition to the aqueous medium, wherein the composition comprises malic acid or a salt thereof.

2. The method of claim 1, wherein the composition comprises an organic solvent.

3. The method of claim 2, wherein the organic solvent comprises an alcohol, a hydrocarbon, a ketone, an ether, an alkylene glycol, a glycol ether, an amide, a nitrile, a sulfoxide, an ester, a polyol, or any combination thereof.

4. The method of claim 1, wherein the composition comprises a corrosion inhibitor selected from the group consisting of an imidazoline compound, a quaternary ammonium compound, a quaternary iminium compound, a zwitterionic betaine compound, an amidoamine compound, a pyridinium compound, and any combination thereof.

5. The method of claim 4, wherein the corrosion inhibitor comprises one or more of the following imidazoline compounds: (A) an imidazoline of Formula (I): 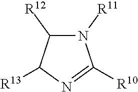
wherein R¹⁰ is a C₁-C₂₀ alkyl or a C₁-C₂₀ alkoxyalkyl group;
R¹² and R¹³ are independently hydrogen or a C₁-C₆ alkyl group; and
R¹¹ is independently hydrogen, a C₁-C₆ alkyl, a C₁-C₆ hydroxyalkyl, an aminoalkyl, an aminoaryl, an aminoarylalkyl, an aminoalkylaryl, or a C₁-C₆ arylalkyl;
(B) an imidazolinium salt of Formula (II): 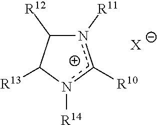
wherein R¹⁰ is a C₁-C₂₀ alkyl or a C₁-C₂₀ alkoxyalkyl group;
R¹² and R¹³ are independently hydrogen or a C₁-C₆ alkyl group;
R¹¹ and R¹⁴ are independently hydrogen, a C₁-C₆ alkyl, a C₁-C₆ hydroxyalkyl, or a C₁-C₆ arylalkyl; and
X⁻ is a halide, a carbonate, a sulfonate, a phosphate, or an anion of an organic carboxylic acid;
(C) a bis-quaternized imidazoline compound of Formula (III): 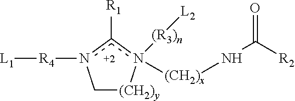
wherein R₁ and R₂ are each independently unsubstituted branched, chain or ring alkyl or alkenyl having from 1 to about 29 carbon atoms; partially or fully oxygenized, sulfurized, and/or phosphorylized branched, chain, or ring alkyl or alkenyl having from 1 to about 29 carbon atoms; or a combination thereof;
R₃ and R₄ are each independently unsubstituted branched, chain or ring alkylene or alkenylene having from 1 to about 29 carbon atoms; partially or fully oxygenized, sulfurized, and/or phosphorylized branched, chain, or ring alkylene or alkenylene having from 1 to about 29 carbon atoms; or a combination thereof;
L₁ and L₂ are each independently absent, H, —COOH, —SO₃H, —PO₃H₂, —COOR₅, —CONH₂, —CONHR₅, or —CON(R₅)₂;
R₅ is each independently a branched or unbranched alkyl, aryl, alkylaryl, alkylheteroaryl, cycloalkyl, or heteroaryl group having from 1 to about 10 carbon atoms;
n is 0 or 1, and when n is 0, L₂ is absent or H;
x is from 1 to about 10; and
y is from 1 to about 5; or
(D) a combination thereof.

6. The method of claim 5, wherein the corrosion inhibitor comprises the imidazoline of Formula (I) or the imidazolinium salt of Formula (II), R¹⁰ is an alkyl mixture of tall oil fatty acid (TOFA), R¹¹ is benzyl, R¹² and R¹³ are each hydrogen, R¹⁴ is hydroxyethyl, and X⁻ is chloride.

7. The method of claim 5, wherein the corrosion inhibitor comprises the bis-quaternized imidazoline compound of Formula (III), R₁ and R₂ are derived from a mixture of tall oil fatty acids and are predominantly a mixture of C₁₇H₃₃ and C₁₇H₃₁, x is 2, y is 1, R₃ and R₄ are —C₂H₂—, and L₁ and L₂ are —CO₂H, —SO₃H, or —PO₃H₂.

8. The method of claim 5, wherein the corrosion inhibitor comprises the bis-quaternized imidazoline compound of Formula (III), R₁ and R₂ independently C₁₆-C₁₈ alkyl; R₄ is —C₂H₂—; x is 2; y is 1; n is 0; L₁ is —COOH, —SO₃H, or —PO₃H₂ and L₂ is absent or H.

9. The method of claim 5, wherein the corrosion inhibitor comprises the quaternary ammonium compound and the bis-quaternized imidazoline compound of Formula (III).

10. The method of claim 4, wherein the corrosion inhibitor comprises a pyridinium compound of Formula (V): 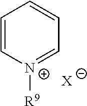
wherein R⁹ is an alkyl group, an aryl group, or an arylalkyl group,
wherein said alkyl groups have from 1 to about 18 carbon atoms; and
X⁻ is a halide.

11. The method of claim 4, wherein the corrosion inhibitor further comprises a member selected from the group consisting of an alkoxylated amine, a phosphate ester, a monomeric fatty acid, an ester of an alcoholamine, an oligomeric fatty acid, and any combination thereof.

12. The method of claim 1, wherein the composition comprises from about 5 wt. % to about 95 wt. % of the malic acid.

13. The method of claim 4, wherein the composition comprises from about 15 wt. % to about 30 wt. % of the malic acid, from about 20 wt. % to about 40 wt. % of the organic solvent, and from about 15 wt. % to about 30 wt. % of the corrosion inhibitor.

14. The method of claim 1, wherein the composition further comprises a compound of formula HS—(CH₂)ₙOH, wherein n is 2-6.

15. The method of claim 1, wherein the composition further comprises an asphaltene inhibitor, a paraffin inhibitor, a scale inhibitor, an emulsifier, a water clarifier, a dispersant, an emulsion breaker, a hydrogen sulfide scavenger, a gas hydrate inhibitor, a biocide, a pH modifier, an antifoam, a surfactant, or any combination thereof.

16. The method of claim 1, wherein a surface in the aqueous system comprises the iron sulfide deposit.

17. The method of claim 1, wherein the method further inhibits corrosion of a metallic surface in the aqueous system.

18. A method of inhibiting corrosion of a metallic surface in an aqueous system, comprising:
adding a composition to the aqueous medium, wherein the composition comprises malic acid or a salt thereof, and
a corrosion inhibitor selected from the group consisting of an imidazoline compound, a quaternary ammonium compound, a quaternary iminium compound, a zwitterionic betaine compound, an amidoamine compound, a pyridinium compound, and any combination thereof.

19. The method of claim 18, wherein the composition comprises an additional component selected from the group consisting of allaric acid, altaric acid, altraric acid, altronic acid, arabinaric acid, arabinonic acid, citric acid, dihomocitric acid, fructuronic acid, fuconic acid, fumaric acid, galactaric acid, galactonic acid, galacturonic acid, glucaric acid, glucoheptonic acid, gluconic acid, glucuronic acid, gulonic acid, homocitric acid, homoisocitric acid, idaric acid, idonic acid, iduronic acid, isocitric acid, mannaric acid, mannonic acid, octulosonic acid, rhamnonic acid, ribonic acid, tagaturonic acid, xylonic acid, xyluronic acid, tartaric acid, tatronic acid, glyceric acid, malonic acid and pantoic acid, a salt of any of these acids, and any combination thereof.

20. The method of claim 18, wherein the composition further comprises a pH modifier.
